(19) United States
(12) Patent Application Publication
(10) Pub. No.: US 2013/0040278 A1
(43) Pub. Date: Feb. 14, 2013

(54) Enhanced integrated journal

(71) Applicants: Osman Rashid, Fremont, CA (US); Babur Habib, Santa Clara, CA (US); David Straus, Los Altos, CA (US); Robert Nagy, Cluj Napoca (RO); Christophe Gillette, Mountain View, CA (US); Renee Rashid, Fremont, CA (US)

(72) Inventors: Osman Rashid, Fremont, CA (US); Babur Habib, Santa Clara, CA (US); David Straus, Los Altos, CA (US); Robert Nagy, Cluj Napoca (RO); Christophe Gillette, Mountain View, CA (US); Renee Rashid, Fremont, CA (US)

(73) Assignee: KNO, INC., Santa Clara, CA (US)

(21) Appl. No.: 13/206,472

(22) Filed: Aug. 9, 2011

(51) Int. Cl. G09B 7/00

(52) U.S. Cl. 434/362

(57) ABSTRACT

An apparatus and method to provide a more interactive book learning experience. The invention provides an interactive quiz component to book figures. Figures within an electronic document can be enlarged by a user input such as a touch gesture. Selected information from the enlarged figure can be hidden and used as an interactive quiz. Feedback and options for further review or interactions are provided based on user input.

### FIELD OF THE INVENTION

The invention relates generally to electronic devices. More particularly, the invention relates to an electronic device used to read educational electronic documents.

### BACKGROUND OF THE INVENTION

Over time, more and more information has become available on the internet. Many websites have an educational slant and aim to proactively teach, as can be done in a traditional classroom setting, rather than just serve as a reference type resource. One way these websites have been more proactive is to utilize interactive online quizzes to teach selected topics. The website provides questions related to a particular topic and accepts input for each question. Feedback on entered quiz answers is then provided either after each question is answered or after all of the questions of the quiz have been answered. This type of interactive quiz can be more helpful than simply reading a reference document about the topic because often the interactive aspect allows more information to be retained. Additionally, an interactive quiz can reveal aspects of a topic the reader had not fully considered.

In the educational environment, more and more textbooks and other documents are available electronically. These textbooks often have some limited electronic interactive features such as bookmarking and highlighting but do not provide the advantages of a more fully interactive learning experience.

### SUMMARY OF THE INVENTION

An apparatus and method to provide a more interactive book learning experience. The invention provides an interactive quiz component to book figures. Figures within an electronic document can be enlarged by a user input such as a touch gesture. Selected information from the enlarged figure can be hidden and used as an interactive quiz. Feedback and options for further review or interactions are provided based on user input.

### BRIEF DESCRIPTION OF THE DRAWINGS

FIG. 1 displays a textbook page with a figure.

FIG. 2 displays a textbook page with an enlarged figure.

FIG. 3 displays a textbook page with an enlarged figure for an interactive quiz.

FIG. 4 displays a textbook page with an interactive quiz.

### DETAILED DESCRIPTION OF THE DRAWINGS

This invention helps meet the described need by providing a way to have improved interactive learning with an electronic book.

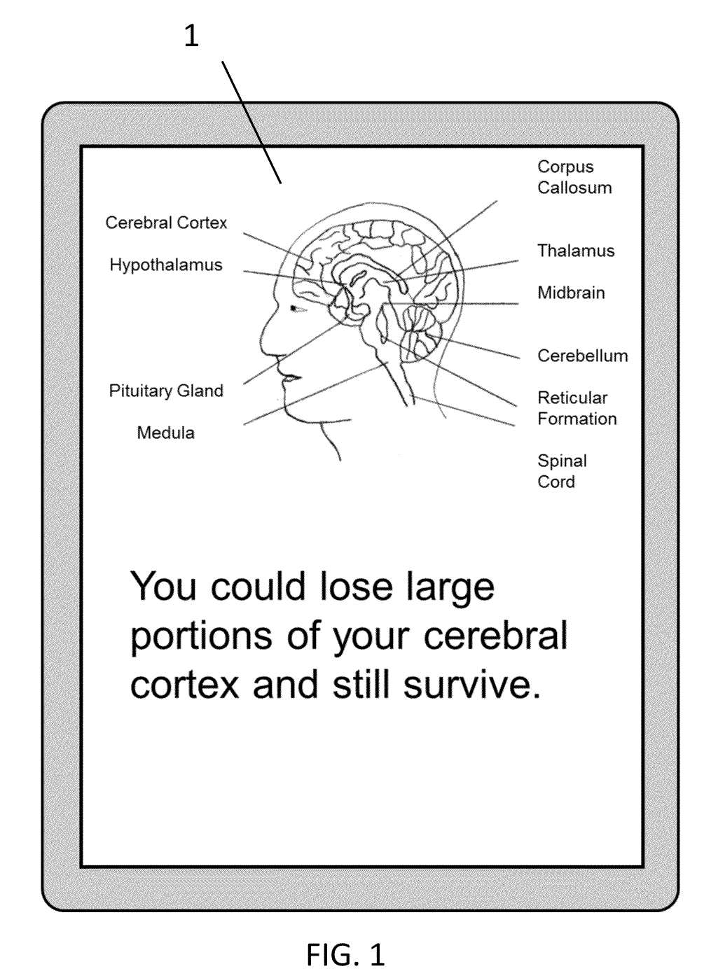

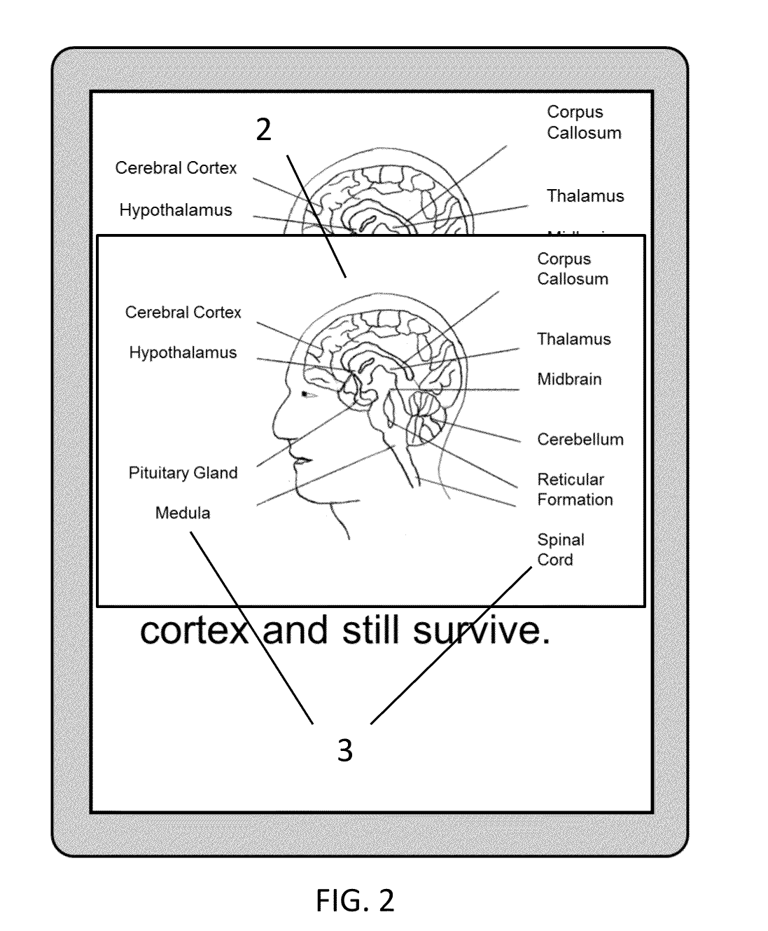

In the educational environment, interactive learning can increase retention and improve the overall learning experience. The instant invention provides an apparatus and method for an interactive learning experience with an electronic book. FIG. 1 depicts a typical page in an electronic textbook. The page has a FIG. 1) that illustrates different parts of the brain. A user gesture such as a double tap on the figure will enlarge the figure as shown in FIG. 2. FIG. 2 shows the enlarged FIG. 2) that can now be used as an interactive quiz. Based on user input, for example, the labels (3) in the FIG. 2) can be erased so that the reader can attempt to recall the different portions of the brain. One capability of this feature is that the user can customize the quiz as well. So instead of all text labels being hidden, the user can choose which are the important ones and configure the quiz to only use the chosen labels for testing.

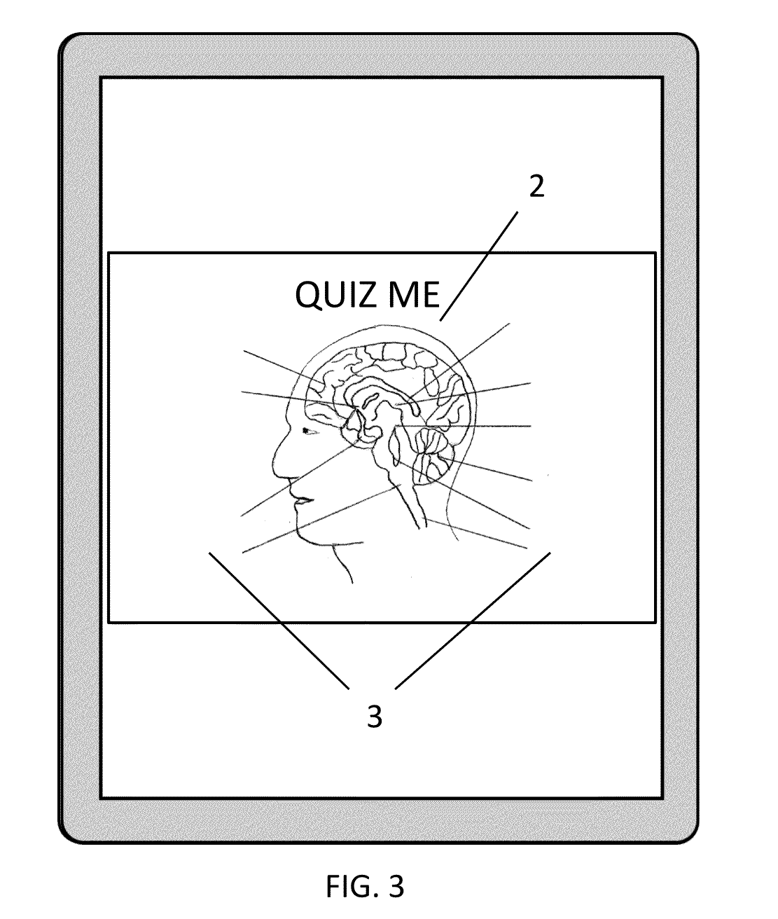

FIG. 3 shows the FIG. 2) with the text of the labels (3) removed. The reader can then input answers for each of the labels and receive feedback on whether the answers were correct. The input can be through gestures, capturing and recognizing handwriting, keypad input, voice etc. For the incorrect answers, the feedback can include a more comprehensive explanation. For example, the reader can be taken to the portion of the text that is related to the correct and incorrect answer.

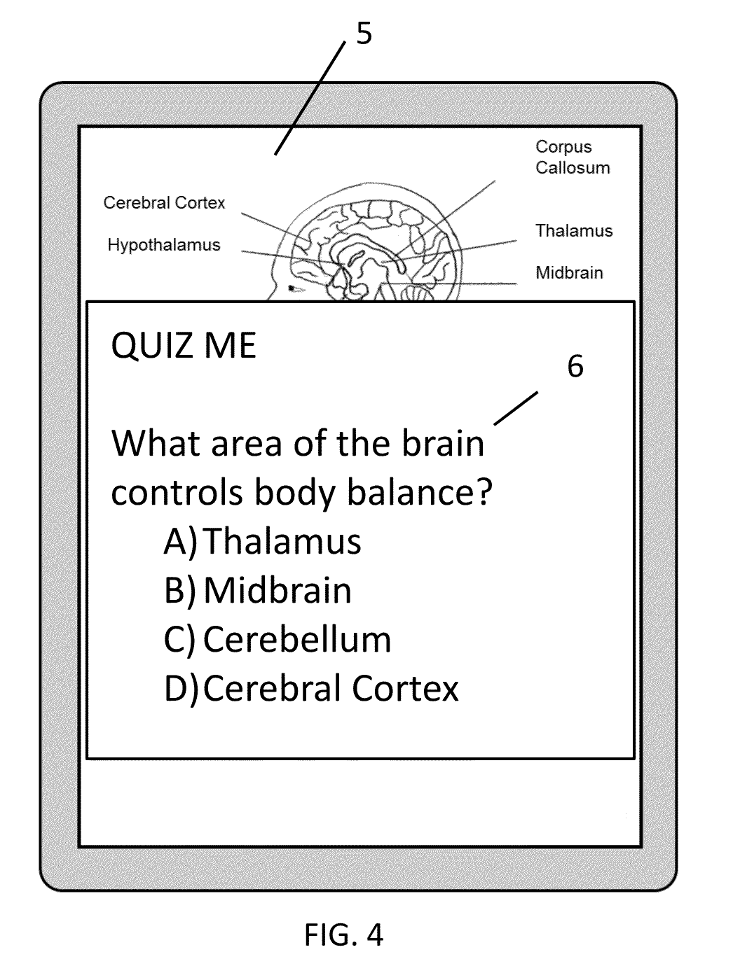

The interactive quiz does not need to focus on figure labels. Instead, a quiz can be generated based on user input and the topic currently being viewed. The questions are selected from a pre-defined question bank where each question is associated with at least one topic. For example, as shown in FIG. 4, when viewing the page (5) user input such as a touch gesture can generate the interactive questions (6). Here the topic of the page is the brain and so the question is selected from the subset of the question back associated with the topic brain.

The reader can then input answers for each of the questions and receive feedback on whether the answers were correct. The input can be through gestures, capturing and recognizing handwriting, keypad input, voice etc. For the incorrect answers, a more comprehensive explanation can be provided. For example, the reader can be taken to the portion of the book that is related to the correct and incorrect answer. Additionally, alternative material external to the current document that is relevant to the quiz related material can be suggested.

In this case, since the topic of the page (5) in FIG. 4 is the brain, the question generated reads “What area of the brain controls body balance and coordination of skilled movement?” with multiple choice answers of thalamus, mid brain, cerebellum and cerebral cortex. If the incorrect answer of mid brain is chosen, the reader can be informed that the correct answer was cerebellum, guided to the portion of the book describing the cerebellum and optionally guided to the portion of the book describing the mid brain.

In another aspect of the invention, the reader will be given the option to chat or email with a tutor on the particular subject area and the reader will have the capability to ask questions on the specific material to their classmates, friends, or anyone using the book through social media features. In this way the electronic book interface facilitates a more comprehensive interactive learning experience.

In the claims:

1. A computer readable medium capable of storing a program facilitating the following steps:
identifying the topic of a portion of an electronic document;
selecting a question based on said topic;
displaying said question;
receiving input in response to displayed question; and
displaying feedback based on said input;

2. The computer readable medium of claim one capable of storing a program facilitating the following additional step:
providing links to external interactive media related to said topic.

3. The computer readable medium of claim one wherein said feedback includes information on whether said input correctly answers said question.

4. The computer readable medium of claim one wherein said feedback includes links to sections of said electronic document related to said question.

5. The computer readable medium of claim one wherein said feedback includes links to sections of said electronic document related to said input.

6. The computer readable medium of claim one wherein said feedback includes links to information external to said electronic document and related to said question.

7. A method for generating an electronic document comprising the steps of:
identifying the topic of a portion of an electronic document;
selecting a question based on said topic;
displaying said question;
receiving input in response to displayed question; and
displaying feedback based on said input;

8. The method of claim seven comprising the following additional step:
providing links to external interactive media related to said topic.

9. The method of claim seven wherein said feedback includes information on whether said input correctly answers said question.

10. The method of claim seven wherein said feedback includes links to sections of said electronic document related to said question.

11. The method of claim seven wherein said feedback includes links to sections of said electronic document related to said input.

12. The method of claim seven wherein said feedback includes links to information external to said electronic document and related to said question.

13. A computer readable medium capable of storing a program facilitating the following steps:
receiving input to select a figure with labels within an electronic document;
enlarging the display size of said figure;
removing said labels from said figure;
receiving input corresponding to said labels; and
displaying feedback based on said input corresponding to said labels.

14. The computer readable medium of claim thirteen capable of storing a program facilitating the following additional step:
providing links to external interactive media related to said topic.

15. The computer readable medium of claim thirteen wherein said feedback includes information on whether said input correctly answers said question.

16. The computer readable medium of claim thirteen wherein said feedback includes links to sections of said electronic document related to said question.

17. The computer readable medium of claim thirteen wherein said feedback includes links to sections of said electronic document related to said input.

18. The computer readable medium of claim thirteen wherein said feedback includes links to information external to said electronic document and related to said question.

19. A method for generating an electronic document comprising the steps of:
receiving input to select a figure with labels within an electronic document;
enlarging the display size of said figure;
removing said labels from said figure;
receiving input corresponding to said labels; and
displaying feedback based on said input corresponding to said labels.

20. The method of claim nineteen comprising the following additional step:
providing links to external interactive media related to said topic.

21. The method of claim nineteen wherein said feedback includes information on whether said input correctly answers said question.

22. The method of claim nineteen wherein said feedback includes links to sections of said electronic document related to said question.

23. The method of claim nineteen wherein said feedback includes links to sections of said electronic document related to said input.

24. The method of claim nineteen wherein said feedback includes links to information external to said electronic document and related to said question.
